(19) United States
(12) Patent Application Publication
(10) Pub. No.: US 2024/0299243 A1
(43) Pub. Date: Sep. 12, 2024

(54) SINUSITIS TREATMENT PERCUSSIVE DEVICE

(71) Applicant: Noah Greyson Levi, Wilton, CT (US)

(72) Inventor: Noah Greyson Levi, Wilton, CT (US)

(21) Appl. No.: 18/598,222

(22) Filed: Mar. 7, 2024

Related U.S. Application Data
(60) Provisional application No. 63/489,328, filed on Mar. 9, 2023.

(51) Int. Cl. A61H 23/02

(52) U.S. Cl. CPC A61H 23/02; A61H 2201/1607; A61H 2201/501; A61H 2201/5025; A61H 2201/5035; A61H 2205/022

(57) ABSTRACT

An example percussive treatment device is provided. The device includes a housing, one or more attachment means disposed at least partially within the housing, and one or more vibration elements disposed at least partially within the housing. The one or more magnets vibration elements are configured to be selectively actuated to generate vibration of the housing.

### CROSS-REFERENCE TO RELATED APPLICATIONS

This application claims the benefit of a co-pending U.S. Provisional Patent Application No. 63/489,328, which was filed on Mar. 9, 2023. The entire content of the foregoing provisional application is incorporated herein by reference.

### TECHNICAL FIELD

The present invention relates to a device for the treatment of sinusitis and, more particularly, to a hands-free wearable device that utilizes percussive therapy to treat sinusitis.

### BACKGROUND

Numerous individuals suffer from sinusitis experience congestion, pressure, and similar symptoms. Existing devices used to treat these symptoms are generally not effective and are typically expensive. As such, most patients rely on antibiotics to alleviate their sinusitis symptoms. Repeated usage of antibiotics can build up resistance to the antibiotics, which results in less effective results and can be detrimental to one's health in the long run.

As such, a need exists for a non-intrusive, hands-free wearable device that utilizes percussive therapy to alleviate the problems mentioned above in treating sinusitis. These and other needs are addressed by the exemplary sinusitis treatment percussive device discussed herein.

### SUMMARY

Embodiments of the present disclosure provide a sinusitis treatment percussive device that relies on non-invasive treatment to deliver vibrational therapy to the user. The percussive device generally includes a housing that contains one or more vibrating elements and one or more motors. A medical grade double-sided adhesive can be used to secure releasably the percussive device to the user's face over the maxilla bone to target the maxillary sinuses for treatment. The percussive device is configured to apply vibrations and/or pulses of vibrations directed to the maxillary sinuses to treat sinusitis without the use of antibiotics. The percussive device includes an internal processing device that can communicate with an external user interface (e.g., a graphical user interface) to control operation of the percussive device. A user can thereby use the external device to, e.g., turn on/off the device, regulate the intensity of the vibrations, regulate the type of vibration pulses generated the device, set the length of treatment, combinations thereof, or the like. In some embodiments, the ability to turn on/off and regulate the intensity, pulses and/or timeframe for treatment can be incorporated into the percussive device itself such that the user does not necessitate an external device for operation.

In accordance with embodiments of the present disclosure, an exemplary percussive treatment device (e.g., a sinusitis percussive treatment device) is provided. The device includes a housing, one or more attachment means disposed at least partially within the housing, and one or more vibration elements disposed at least partially within the housing. The one or more vibration elements are configured to be selectively actuated to generate vibration of the housing.

In some embodiments, the housing can be a teardrop-shaped in configuration. In some embodiments, the housing can include a first end and an opposing second end, the first end defining a width smaller than a width of the opposing second end. The housing can be dimensioned to fit on a face of a user over a maxillary sinus area, and the vibration generated by the one or more vibration elements can be used to treat sinusitis of the maxillary sinus area.

The housing includes a top surface and an opposing bottom surface. The device can include an attachment member coupled to the bottom surface of the housing. In some embodiments, the attachment member can be removably coupled to the bottom surface of the housing. The attachment member can include an adhesive bottom surface configured to be removably attached to skin of a user. The attachment member can include a removable film that, once removed, exposes an adhesive surface.

In some embodiments, the generated vibration can include a uniform vibration frequency level. In some embodiments, the generated vibration can include different vibration frequency levels and patterns selectable by a user. In some embodiments, the device can include a visual indicator for indicating an operational status of the percussive treatment device. In some embodiments, the device can include a transmitter and receiver disposed at least partially within the housing for communication with an external controller for regulating operation of the percussive treatment device. The one or more vibration elements can be selectively actuated to generate the vibration of the housing to provide percussive or vibrational treatment to sinuses of a user.

In accordance with embodiments of the present disclosure, an exemplary percussive treatment system is provided. The system includes a percussive treatment device and an external device. The percussive treatment device includes a housing, one or more attachment means disposed at least partially within the housing, and one or more vibration elements disposed at least partially within the housing. The one or more vibration elements are configured to be selectively actuated to generate vibration of the housing. The external device is configured to communicate with the percussive treatment device to initiate or stop generation of the vibration of the housing.

In some embodiments, the external device can include a user interface, a transmitter, and a receiver for communication with the percussive treatment device. The housing of the percussive treatment device is dimensioned to fit on a face of a user over a maxillary sinus area to apply the generated vibration from the housing to the maxillary sinus area and treat sinusitis of the maxillary sinus area. In some embodiments, the percussive treatment device can include an attachment member coupled to a bottom surface of the housing. The attachment member can include a removable film that, once removed, exposes an adhesive surface for attachment of the percussive treatment device to skin of a user over a maxillary sinus area.

In accordance with embodiments of the present disclosure, an exemplary method of percussive treatment is provided. The method includes removably attaching a percussive treatment device to skin of a user. The percussive treatment device includes a housing, one or more attachment means disposed at least partially within the housing, and one or more vibration elements disposed at least partially within the housing. The method includes selectively actuating the one or more vibration elements to generate vibration of the housing to apply vibrational therapy through the skin of the user.

Any combination and/or permutation of embodiments is envisioned. Other objects and features will become apparent from the following detailed description considered in conjunction with the accompanying drawings. It is to be understood, however, that the drawings are designed as an illustration only and not as a definition of the limits of the present disclosure.

### BRIEF DESCRIPTION OF THE DRAWINGS

To assist those of skill in the art in making and using the sinusitis treatment percussive device, reference is made to the accompanying figures, wherein:

FIG. 1 shows a detailed view of a percussion motor coupled to wiring during testing of an exemplary sinusitis treatment percussive device in accordance with embodiments of the present disclosure. is a picture of a detail view of an embodiment of the present invention, showing a percussion motor coupled to wiring;

FIG. 2 shows a top view of a prototype of an exemplary sinusitis treatment percussive device in accordance with embodiments of the present disclosure.

FIG. 3 shows a perspective view of an exemplary sinusitis treatment percussive device in accordance with embodiments of the present disclosure, including percussion motors adhered to a tape substrate prior to securement to an adhesive patch for testing.

FIG. 4 shows a perspective view of an exemplary sinusitis treatment percussive device in use on a patient in accordance with embodiments of the present disclosure.

FIG. 5 is a top view of an exemplary sinusitis treatment percussive device in accordance with embodiments of the present disclosure, including a single vibrating element.

FIG. 6 is a bottom view of an exemplary sinusitis treatment percussive device in accordance with embodiments of the present disclosure.

FIG. 7 is a perspective view of a motor unit for testing of an exemplary sinusitis treatment percussive device in accordance with embodiments of the present disclosure.

FIG. 8 is a perspective and detailed view of testing of an exemplary sinusitis treatment percussive device in accordance with embodiments of the present disclosure.

FIG. 9 is a perspective view of an exemplary sinusitis treatment percussive device in accordance with embodiments of the present disclosure, including three vibrating elements.

FIG. 10 is a block diagram of an exemplary sinusitis treatment percussive system in accordance with embodiments of the present disclosure.

### DETAILED DESCRIPTION

The following detailed description is of the best currently contemplated modes of carrying out exemplary embodiments of the present invention. The description is not to be taken in a limiting sense but is made merely for the purpose of illustrating the general principles of the present invention, since the scope of the present invention is best defined by the appended claims.

The present invention provides a percussive treatment device for alleviating sinusitis symptoms. The percussive treatment device utilizes an alternative form of therapy, specifically percussive treatment, to treat sinusitis. The device uses percussion motors to vibrate against one's sinuses, breaking down mucus, alleviating pressure, and reducing congestion. In particular, the percussive treatment device includes a housing that encloses one or more vibrating elements (e.g., magnets) and one or more motors for generating vibrations or vibration pulses. The device is configured to be removably attached to the user's face over the maxilla bone to target the maxillary sinuses with the generated vibrations. The repetitive vibration pulses generate pressure in the area underneath the device, which acts to break down mucus, alleviate pressure, and reduce congestion to clear the maxillary sinuses. The device therefore provides a non-invasive means for treatment of sinusitis. The device is hands-free and wearable, making it easy to use during both stationary and mobile usage. It is a short-term solution for treating sinusitis and allergy related symptoms, and serves as a substitute for short-term antibiotics. Therefore, the device helps reduce antibiotic usage and reduces antibiotic resistance over time for patients.

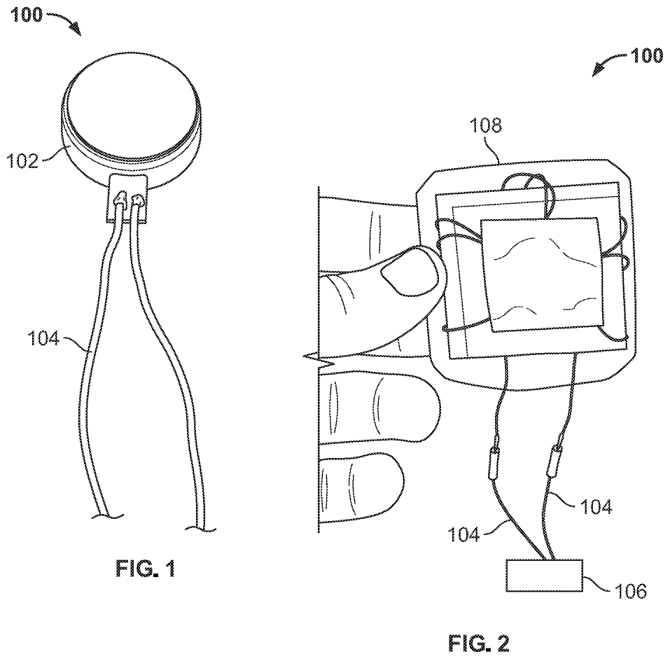

With reference to FIGS. 1-4, perspective and detailed views of an exemplary sinusitis treatment percussive device 100 (hereinafter “device 100”) are provided. In particular, FIGS. 1-4 illustrate an initial prototype of the device 100. As discussed herein, the device 100 uses percussion motors in a housing attachable to the user's cheeks with an adhesive patch to treat sinusitis. FIG. 1 illustrates a percussive motor 102 that can be soldered or otherwise operably coupled together with one or more other percussive motors 102 (if needed) and electrically attached to wires 104.

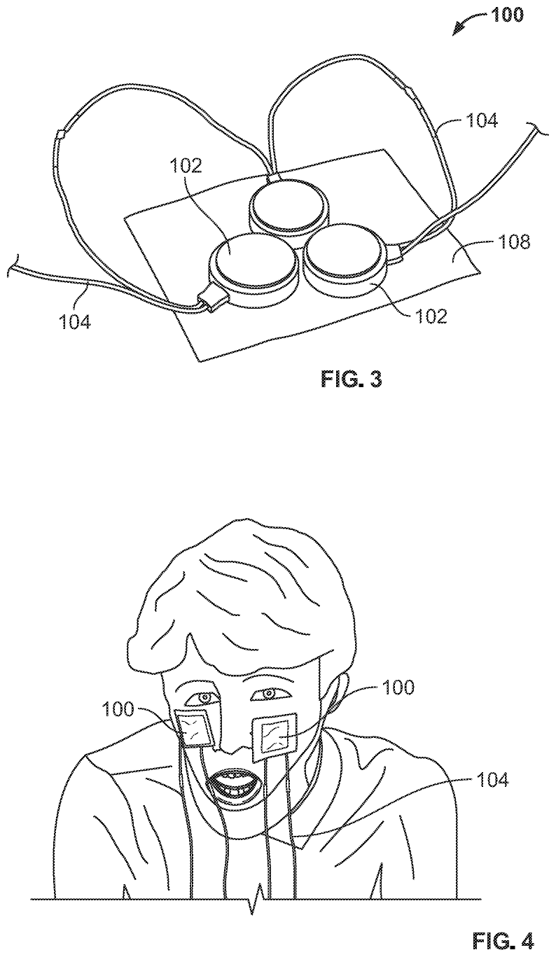

As illustrated in FIG. 2, the wires 104 are electrically connected to a controller 106 (e.g., a compact integrated circuit, a processing device, combinations thereof, or the like) that is electrically and operably connected to a power source (e.g., a rechargeable battery, or the like). The controller 106 can be programmed to execute code (which may be stored in a database or memory within the controller 106) that causes the percussion motor(s) 102 to operate at a set frequency and/or a set pattern of frequencies. In some embodiments, the frequency of operation can be, e.g., pulsing patterns, on/off patterns, constant vibration, or the like. The frequency of the percussion motors 102 can be adjusted using a hardware or software dial on a user device and/or on the device 100. The percussive motors 102 were secured to an adhesive patch 108 in an enclosed manner. The adhesive patch 108 with the percussion motors 102 inside can be placed against an individuals' sinuses and applied like an adhesive bandage. The user does not need to use their hands and can allow the device 100 to run for whatever time period they desire.

FIG. 3 shows the device 100 with three percussive motors 102. It should be understood that the device 100 can include one or more percussive motors 102. With reference to FIGS. 2 and 4, for prototype testing purposes, the wires 104 extend away from the adhesive patch 108 for connection to a power source and a controller. However, as discussed herein, the power source and/or the controller can be incorporated into the device 100 for a self-contained operation. In some embodiments, the percussive motors 102 can be connected wirelessly with the controller 106 of an external user device and powered via, for example, batteries or rechargeable batteries within the device 100. Other configurations may be appropriate and are in accordance with the present invention, such that the functionality described herein is achieved.

In operation, the percussion motors 102 provide small frequency vibrations that break apart the mucus within the sinuses and stimulate cilia movement. In some embodiments, the generated vibration can be a continuous frequency or pattern of vibrations. In some embodiments, the generated vibration can be based on a pattern or frequency of vibrations selected by the user through the controller. The vibration allows mucus to clear through the user's system, reducing pressure and congestion in the process. Incorporating percussion motors 102 within or on an adhesive patch allows the user to simply stick the device 100 against their face for a hands-free operation of the device 100. After use, the device 100 device can be easily removed from the user's face. The adhesive patch can be replaced after each use to ensure sufficient adhesive is used each time for maintaining a position of the device 100 on the maxillary sinuses. In some embodiments, the device 100 can also be used to apply percussion therapy wirelessly and hands-free to other parts of the body to stimulate blood flow and/or for massage relief. In some embodiments, the device 100 can be used as, e.g., a wireless massage device, to treat congestion and pressure caused by allergies, combinations thereof or the like.

The percussive treatment device 100 can be fabricated by coupling the one or more percussion motors to a power source. The motors can subsequently be placed within or against an adhesive. The device 100 is small enough to fit on the desired user's face.

The system and method for controlling the motors described above is for purposes of example only and may be implemented in any type of computer system or programming or processing environment, or in a computer program, alone or in conjunction with hardware. The present invention may also be implemented in software stored on a non-transitory computer-readable medium and executed as a computer program on a general purpose or special purpose computer. For clarity, only those aspects of the system germane to the invention are described, and product details well known in the art are omitted. It should thus be understood that the invention is not limited to any specific computer language, program, or computer.

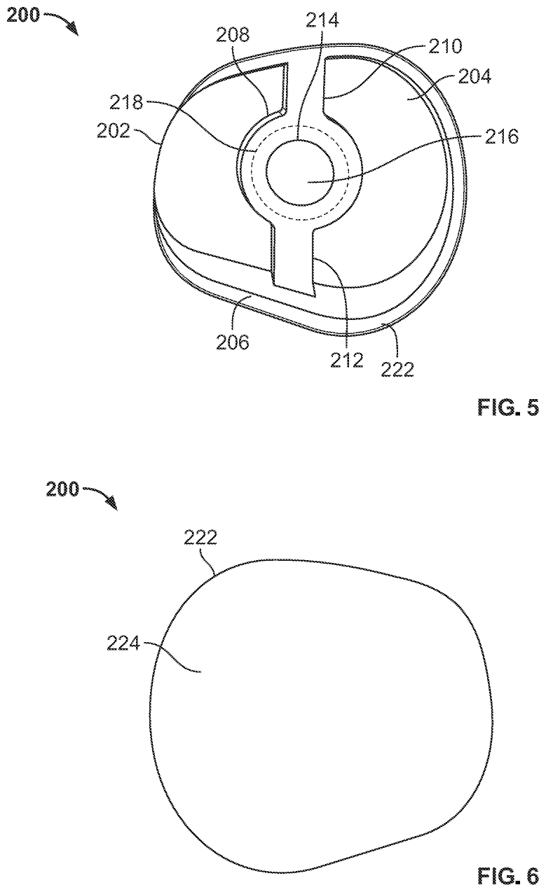

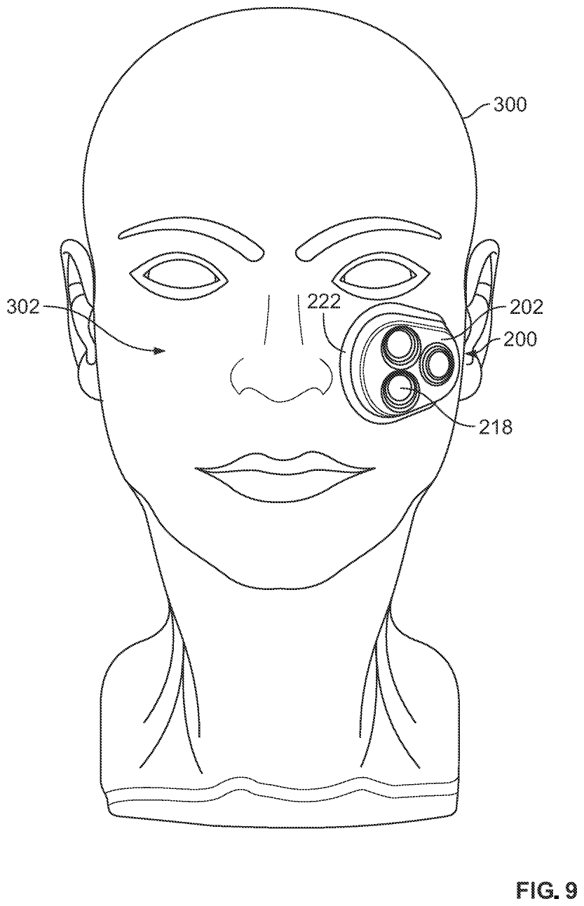

With reference to FIGS. 5 and 6, top and bottom views of an exemplary sinusitis treatment percussive device 200 (hereinafter “device 200”) are provided. The device 200 includes a housing 202 with a top or outwardly facing surface 204 and an opposing bottom surface 206. In some embodiments, the bottom surface 206 can be substantially flat or planar. In some embodiments, the bottom surface 206 can be slightly concave to conform to the user's anatomy for improved placement over the maxillary sinus. In some embodiments, the housing 202 can define a substantially oval or teardrop-shaped configuration. For example, one end (e.g., the left end) of the housing 202 can be smaller in width than the opposing end (e.g., the right end) of the housing 202 such that a gradual reduction or increase in width occurs. This configuration provides an improved fit on the user's face over the maxillary sinus and provides for the optimal coverage of the maxillary sinus to apply vibrations in the desired areas (see, e.g., FIG. 9). In some embodiments, the device 200 can be dimensioned to fit within an area of about 1.61 inches by 1.61 inches over the maxillary sinus.

The top surface 204 of the housing 202 can be substantially flat or convex. The top surface 204 of the housing 202 can include one or more grooves formed therein. For example, the housing 202 can include a circular central groove 208 and linear grooves 210, 212 extending outward on opposing sides towards edges of the top surface 204. The housing includes a circular opening 214 formed within the central groove 208. The opening 214 is configured and dimensioned complementary to an attachment means 216 (e.g., a magnetic disc, magnetic cylinder, magnetic lining, magnetic material, or the like) such that the attachment means 216 can be installed via a press fit and/or with adhesive to the bottom of the opening 214. In some embodiments, the attachment means 216 can be a press fit within the opening 214 configured to receive and maintain the position of a vibrating element 218 via a friction fit (e.g., no additional material). In some embodiments, the attachment means 216 can be any way of attaching the vibrating element 218 to the housing 202. Although one attachment means 216 is shown, in some embodiments, multiple attachment means 216 can be used (see, e.g., FIG. 9). In such embodiments, the housing 202 can include multiple openings 214, each configured to receive a respective attachment means 216.

The housing 202 is configured to receive and enclose one or more vibration elements 218 (e.g., percussive motors, or the like). In some embodiments, the vibration elements 218 can be (but are not limited to), e.g., Vybronics Inc. Part VC0625B001L, Vybronics Inc. Part VC0827B005F, Vybronics Inc. Part VC1020B11IF, Vybronics Inc. Part VC1434B002U, PUI Audio Part HD_EMC1203-LW, Seed Part 31604001, Parallax Part 28822, Tatoko Part B07Q1ZV4MJ, combinations thereof, or the like. In some embodiments, the housing 202 can include openings formed in the bottom surface 206 that provide access to a hollow interior, allowing for installation of the attachment means 216 and the vibration elements 218 within the housing 202. In some embodiments, the housing 202 can include openings formed in the top surface 204 for installation of the attachment means 216 and the vibration elements 218, and a cover can be installed over the openings to fully enclose the internal components of the device 200. In some embodiments, the attachment means 216 and/or the vibration elements 218 can be interchangeable depending on the type, magnitude and frequency of vibration to be applied by the device 200.

The device 200 includes an attachment material 222 coupled to the bottom surface 206 of the housing 202. In some embodiments, the attachment member 222 can be a double-sided adhesive tape (e.g., a medical grade adhesive tape, ADHEX® adhesive tape, or the like). One side of the material 222 can be coupled to the bottom surface 206 of the housing 202, and the opposing side of the member 222 can include a removable film 224 that allows the user to selectively remove the film 224 before application of the device 200 to the user's face. The member 222 provides sufficient adhesive to secure the device 200 to the user's face and maintain the position of the device 200 during use. After use, the device 200 can be peeled off of the user's face and the attachment member 222 can be discarded. Replacement attachment member 222 can be secured to the bottom surface 206 of the housing 202 when the device 200 is to be used at a later time.

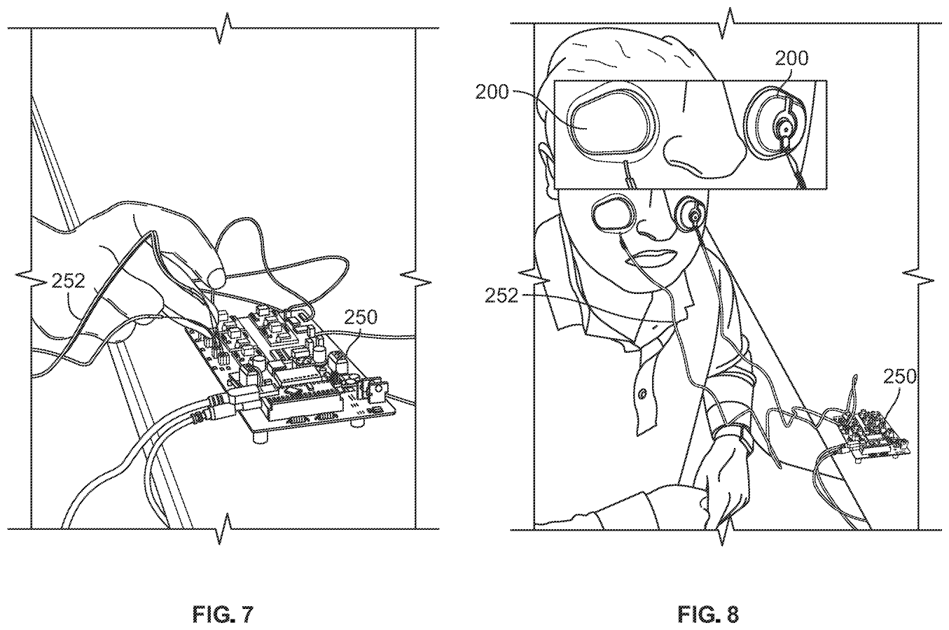

FIGS. 7 and 8 illustrate testing of the device 200. For testing purposes, as illustrated in FIG. 7, an external controller 250 was used to actuate the vibration elements via wires 252. However, as discussed with respect to FIGS. 5 and 6, the device 200 incorporates the percussive motors and the actuator within the housing, and an external controller can be used to operate the device 200 via wireless means. In some embodiments, the device can be used on its own without the use of an external device (e.g., a stand-alone device operation). In FIG. 8, the devices 200 are shown as attached to the skin of the user over the maxillary sinuses on either side of the face. The device 200 is configured to be positioned within an approximately 2.5 in² area on top of the maxilla bone below the eye of the user to deliver the vibration impact non-invasively in an effective manner. The size and shape of the device 200 is selected to ensure an optimal amount of percussive therapy is provided by the device 200

FIG. 9 shows the device 200 releasably attached to an area 302 of the subject 300 over the maxillary sinuses. The device 200 is substantially similar to the device of FIG. 5, except for three vibrating elements 216 being used. In such embodiments, the housing 202 can include three openings, each configured to receive a respective vibrating element 218. As illustrated in FIG. 9, the teardrop or tapering width shape of the device 200 ensures that the devices 200 provides a maximum area of coverage directly below the eye of the user and adjacent to the nose, with a smaller area of coverage laterally in the direction of the user's ear. This configuration provides an optimal coverage of the area 302 to direct the vibration pulses to the maxillary sinuses, ensuring optimal results for clearing sinus blockage of the user 300.

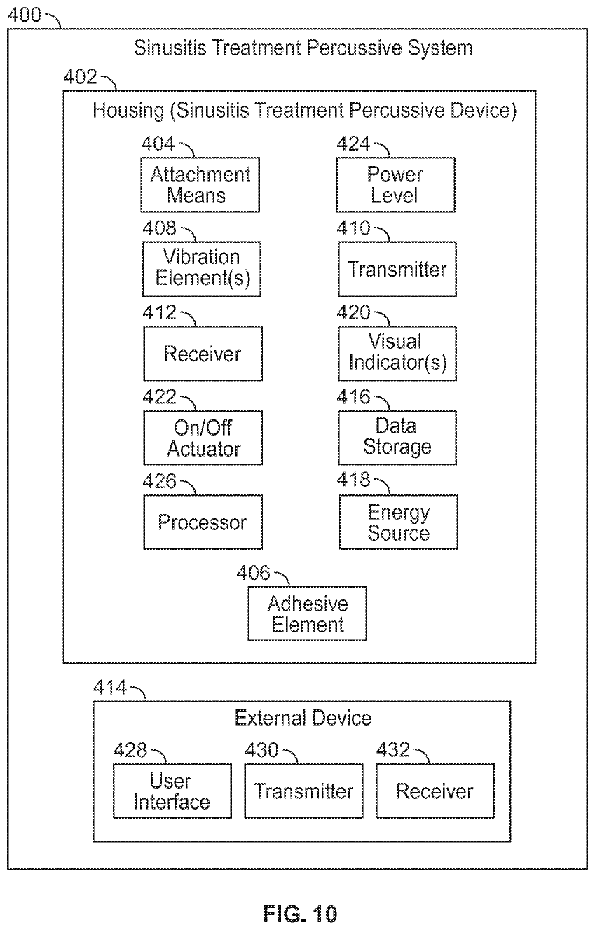

FIG. 10 is a block diagram of an exemplary sinusitis treatment percussive system 400. The system 400 includes at least one sinusitis treatment percussive device (e.g., device 200) with a housing 402. The housing 402 can be secured to the skin of the user using an adhesive element 406. The housing 402 can at least partially enclose one or more attachment means 404, and one or more vibration elements 408. In some embodiments, the housing 402 can also include a transmitter 410 and a receiver 412 for communicating wirelessly with an external device 414 for regulating operation of the device. The housing 402 can include a data storage 416, e.g., a database, or the like, for storing software instructions for operating the device. Such instructions can include, e.g., vibration patterns, vibration levels, frequencies, times for operation, combinations thereof, or the like. The housing 402 can include an energy source 418 (e.g., a rechargeable battery, or the like) for operating the other components of the device. The housing 402 can include a port for connecting the energy source 418 to an outlet for recharging.

In some embodiments, the housing 402 can include one or more visual indicators 420 (e.g., light emitting diodes (LEDs), or the like) to indicate the status of operation of the device. For example, the visual indicators 420 can use different colors to indicate if the device requires recharging, the level of operation of the device, or the like. The housing 402 can include an on/off actuator 422 for operating the device, and can include a power level 424 dial or actuator for varying the level and/or pattern of percussive therapy provided by the device. In some embodiments, the actuator 422 and the power level 424 can be incorporated into the same element, e.g., a dial, or the like. In some embodiments, the device can include a graphical user interface for operating the device. The housing 402 can include a processor 426 or processing device for controlling operation of the components of the device.

The external device 414 can be a specifically dedicated device for the system 400, or can be a non-dedicated device, such as the user's smart phone with a software application for controlling the percussive treatment device. The external device 414 can include a user interface 428 (e.g., a graphical user interface), a transmitter 430, and a receiver 430 for communicating instructions for operation to the percussive treatment device. In such embodiments, the device 414 can be used to turn on/off the treatment device, and to regulate the type of percussive treatment (and length of treatment) provided by the device. In some embodiments, the percussive treatment device can be operated without the use of an external device 414 (e.g., using controls on the percussive treatment device itself).

While exemplary embodiments have been described herein, it is expressly noted that these embodiments should not be construed as limiting, but rather that additions and modifications to what is expressly described herein also are included within the scope of the invention. Moreover, it is to be understood that the features of the various embodiments described herein are not mutually exclusive and can exist in various combinations and permutations, even if such combinations or permutations are not made express herein. without departing from the spirit and scope of the invention.

1. A percussive treatment device, comprising:
a housing;
one or more attachment means disposed at least partially within the housing; and
one or more vibration elements disposed at least partially within the housing;
wherein the one or more vibration elements are configured to be selectively actuated to generate vibration of the housing.

2. The percussive treatment device of claim 1, wherein the housing is teardrop-shaped in configuration.

3. The percussive treatment device of claim 1, wherein the housing includes a first end and an opposing second end, the first end defining a width smaller than a width of the opposing second end.

4. The percussive treatment device of claim 1, wherein the housing is dimensioned to fit on a face of a user over a maxillary sinus area, and the vibration generated by the one or more vibration elements treats sinusitis of the maxillary sinus area.

5. The percussive treatment device of claim 1, wherein the housing includes a top surface and an opposing bottom surface.

6. The percussive treatment device of claim 5, comprising an attachment member coupled to the bottom surface of the housing.

7. The percussive treatment device of claim 6, wherein the attachment member is removably coupled to the bottom surface of the housing.

8. The percussive treatment device of claim 6, wherein the attachment member includes an adhesive bottom surface configured to be removably attached to skin of a user.

9. The percussive treatment device of claim 6, wherein the attachment member includes a removable film that, once removed, exposes an adhesive surface.

10. The percussive treatment device of claim 1, wherein the generated vibration includes a uniform vibration frequency level.

11. The percussive treatment device of claim 1, wherein the generated vibration includes different vibration frequency levels and patterns selectable by a user.

12. The percussive treatment device of claim 1, comprising a visual indicator for indicating an operational status of the percussive treatment device.

13. The percussive treatment device of claim 1, comprising a transmitter and receiver disposed at least partially within the housing for communication with an external controller for regulating operation of the percussive treatment device.

14. The percussive treatment device of claim 1, wherein the one or more vibration elements are selectively actuated to generate the vibration of the housing to provide percussive or vibrational treatment to sinuses of a user.

15. A percussive treatment system, comprising:
a percussive treatment device, including:
a housing;
one or more attachment means disposed at least partially within the housing; and
one or more vibration elements disposed at least partially within the housing;
wherein the one or more vibration elements are configured to be selectively actuated to generate vibration of the housing; and
an external device configured to communicate with the percussive treatment device to initiate or stop generation of the vibration of the housing.

16. The percussive treatment system of claim 15, wherein the external device includes a user interface, a transmitter, and a receiver for communication with the percussive treatment device.

17. The percussive treatment system of claim 15, wherein the housing of the percussive treatment device is dimensioned to fit on a face of a user over a maxillary sinus area to apply the generated vibration from the housing to the maxillary sinus area and treat sinusitis of the maxillary sinus area.

18. The percussive treatment system of claim 15, wherein the percussive treatment device includes an attachment member coupled to a bottom surface of the housing.

19. The percussive treatment system of claim 18, wherein the attachment member includes a removable film that, once removed, exposes an adhesive surface for attachment of the percussive treatment device to skin of a user over a maxillary sinus area.

20. A method of percussive treatment, comprising:
removably attaching a percussive treatment device to skin of a user, the percussive treatment device including(i) a housing, (ii) one or more attachment means disposed at least partially within the housing, and (iii) one or more vibration elements disposed at least partially within the housing; and
selectively actuating the one or more vibration elements to generate vibration of the housing to apply vibrational therapy through the skin of the user.
